(19) United States
(12) Patent Application Publication
(10) Pub. No.: US 2009/0288847 A1
(43) Pub. Date: Nov. 26, 2009

(54) Quick change toolbar construction kit

(76) Inventor: Richard L. Quiring, Stony Plain (CA)

Correspondence Address: Richard L Quring, P.O. Box 2476, Stony Plain, T7Z 1X9, CA

(21) Appl. No.: 12/460,864

(22) Filed: Jul. 27, 2009

(30) Foreign Application Priority Data
Aug. 23, 2004 (CA) 2,477,549

(51) Int. Cl. A01B 63/00

(52) U.S. Cl. 172/250

(57) ABSTRACT

The Quick Change Toolbar Construction Kit provides a parts based kit that when assembled systematically, and temporarily by connecting the quick change parts, one can create an unspecified number of usable toolbar configurations that can perform an unspecified number of tasks by easily transforming a single toolbar into different styles, sizes and configurations, so as to have a usable functioning toolbar that performs tasks including but not limited to tillage, seeding, material handling, landscape work or trailer towing without ever having to disconnect the main frame portion of the toolbar from the three point hitch equipped towing unit. This invention has the capability for quick expansion or reduction of the toolbar in width, length and depth. This quick expansion and reduction capability makes it possible to use the one toolbar in large or small job site applications. It also makes it easier to transport the toolbar from one job site to another, or to store the toolbar in barns or small sheds by quickly disassembling the individual pieces of the invention by simply removing a temporary fastener that is used to secure the toolbar construction kits individual parts together.

### TECHNICAL FIELD OF THE INVENTION

This invention relates to toolbars that attach to three point hitch equipped tractors, trucks and all terrain utility vehicles that operate primarily but not exclusively in agricultural, residential and industrial sectors for a variety of work related tasks such as land and yard maintenance, material handling and trailer towing.

### BACKGROUND OF THE INVENTION

Traditionally manufacturers of three point hitch style toolbars that are used for private and commercial uses, primarily produce them to be, and sell them as singular tasking in their function and operation. This manufacturing process leaves toolbars with a number of major limitations and restrictive characteristics that cannot be easily over come in an after market application.

In the manufacturing industry, a toolbar is primarily referred to as being a toolbar beam. These beams consist of a rigid length of a suitable material. These toolbar can be a single beam or they can be configured as a multiple row of rigidly connected beams creating a toolbar frame work. There are four standard styles of toolbar beams, diamond, square, round and rectangular. Different accessory mounting brackets are usually required when changing sizes and styles of toolbars beams.

Expandability is difficult at best or it may not be achievable at all. The traditional toolbar models are only available in a few predetermined widths, with the most common being in the 60 to 80 inch width range. If a wider or narrower width of toolbar beam is required, it may have to be a special order, in order to facilitate easy transporting of the toolbar from one job site to another, and to have the appropriate carrying capacities and transporting features, or one may have to make it themselves.

Adding to the length of a traditionally manufactured toolbar is a second major restriction or limitation. The length of a toolbar refers to the dimension that extends from its most forward three point hitch connection points rearward, that can include a single or multiple row configurations of rigidly connected toolbar beams. Multiple rows of toolbar beams are connected together with what the industry usually refers to as ties. These ties come in predetermined lengths that are attached to the beams by a process such as welding, or with the use of an accessory tie end connector bracket that matches the style and size of toolbar beam. Both of these methods would form a rigid style of toolbar frame.

Flexibility and exchangeability for a toolbar beam has not been achieved by the manufacturing industry. The toolbar may be able to have some variations within their particular field of operation, such as a toolbar that has been designed and equipped for tillage work may be able to accept different styles of tillage accessory tool pieces, but it would not be possible for the toolbar to be easily adapted to be used for another category of function such as material handling. The traditional method of toolbar construction is limited in its flexibility of use due to its predetermined weight and load bearing capacities.

The traditionally manufactured toolbars are not all that cost efficient because one size does not fit all applications. This results in more duplication of raw material and inventory of finished products for the manufacturer, retailer and the consumer. Affordability has also been affected by the lack of compatibility of exchangeable parts within an individual manufacturer's product line, or between multiple manufacturers' product lines.

The traditional toolbars can be described as being rigid in form and they are for the most part singular tasking for their function.

### SUMMARY OF THE INVENTION

The object of the present invention is to provide a parts based toolbar construction kit that when assembled systematically and temporarily by using the quick change parts, one can create an unspecified number of usable toolbar configurations that can perform an unspecified number of tasks by transforming a single toolbar into different styles, sizes and configurations of the exchangeable parts so as to have a usable functioning toolbar that operates primarily but not exclusively in agriculture, construction, residential and industry.

This toolbar construction kit makes it possible for an operator of a three point hitch equipped tractor, truck or all terrain utility vehicles to perform tasks including but not limited to tillage, seeding, material handling, trailer towing or landscape work without ever having to disconnect the main frame portion of the toolbar from the three point hitch equipped motorized towing unit, such as a tractor.

This toolbar construction kit has the capability for quick expansion or reduction of the toolbar in width, length and depth so that it can meet the ever changing demands on a work site. This capability reduces the need to purchase a large variety of traditionally manufactured rigid style of frame based equipment pieces. This quick expansion and reduction capability makes it possible to use the one toolbar for a wider range of horse powered towing units, and it gives more flexibility in large or small job site applications. This invention also makes it easier to transport the toolbar from one job site to another, or to store the toolbar in barns or small sheds by quickly disassembling the individual pieces of the toolbar construction kit by simply removing a temporary fastener that is used to secure the toolbar construction kits individual parts together.

This toolbar construction kit can lower the cost of investment for manufacturer's, retailers and consumers because there will be less duplication of raw materials, and inventories of finished pre manufactured equipment products.

The main characteristics of the present invention can be summed up in four words; flexibility, changeability, expandability and affordability.

### BRIEF DESCRIPTION OF THE DRAWINGS

1. For a more complete understanding of the invention;

FIG. 1 discloses a side view of a quick change toolbar kit as an assembled main frame configuration.

FIG. 2 shows a side view of an assembled main frame toolbar kit, attached to a three point hitch equipped tractor.

FIG. 3 shows a front view of a toolbar main frame beam, while FIG. 3A shows an end coupler of the for said toolbar beam with an inserted temporary fastener.

FIG. 4 shows a side view of a single adjustable receiver coupler, while FIG. 4A shows the bottom side of the for said adjustable receiver coupler with a weld on connector plate.

FIG. 5 shows a side view of a double adjustable receiver coupler with a weld on center slide tube. FIG. 5A is a front view of the for said double adjustable receiver coupler with a wed on slider tube.

FIG. 6 shows a side view of the 3ph adjustable top link connector arm.

FIG. 7 shows a side view of a 3ph lift arm connector insert tube while FIG. 7A shows a top view of the for said 3ph lift arm connector insert tube.

FIG. 8 is a top view of an assembled quick change toolbar main frame with three different styles of accessory connector arms inserted into the adjustable receiver couplers.

FIG. 9 shows a view of an adjustable receiver coupler end with an inserted temporary fastener.

FIG. 10 is a two dimensional view of a T style accessory connector arm.

FIG. 11 shows a top view of an assembled toolbar main frame, connected to an Toolbar expansion beam.

FIG. 12 is a side view of an expansion coupler. FIG. 12A is an end view of the for said expansion coupler.

FIG. 13 shows a two dimensional view of an expansion tube, while FIG. 13A shows a side view of an expansion tube inserted into a partial view of an adjustable receiver coupler.

### DETAILED DESCRIPTION OF THE INVENTION

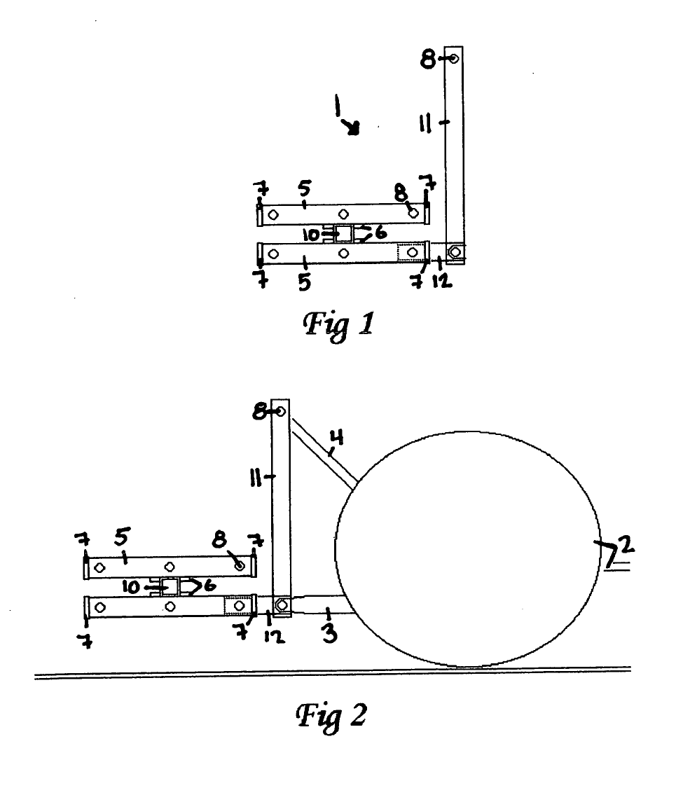

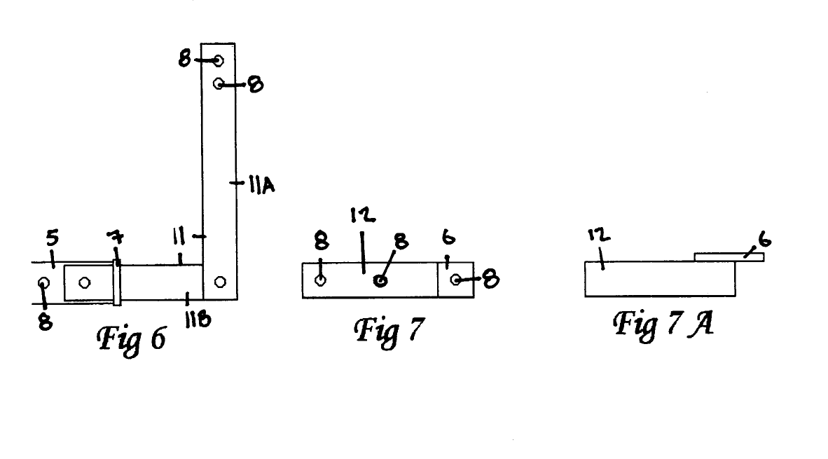

1. In accordance with the object of the invention set forth in the summary of the invention, the quick change toolbar construction kits main frame (1) as shown in FIG. 1 is shown in FIG. 2 mounted on a typical tractor (2) that is equipped with a three point hitch that uses two lower lift arms (3) and a center adjustable top link connector (4) for temporary connection points for attaching the main frame toolbar (1) to the tractor (2). The toolbar kits connecting hardware will be discussed later under FIGS. 6 and 7.

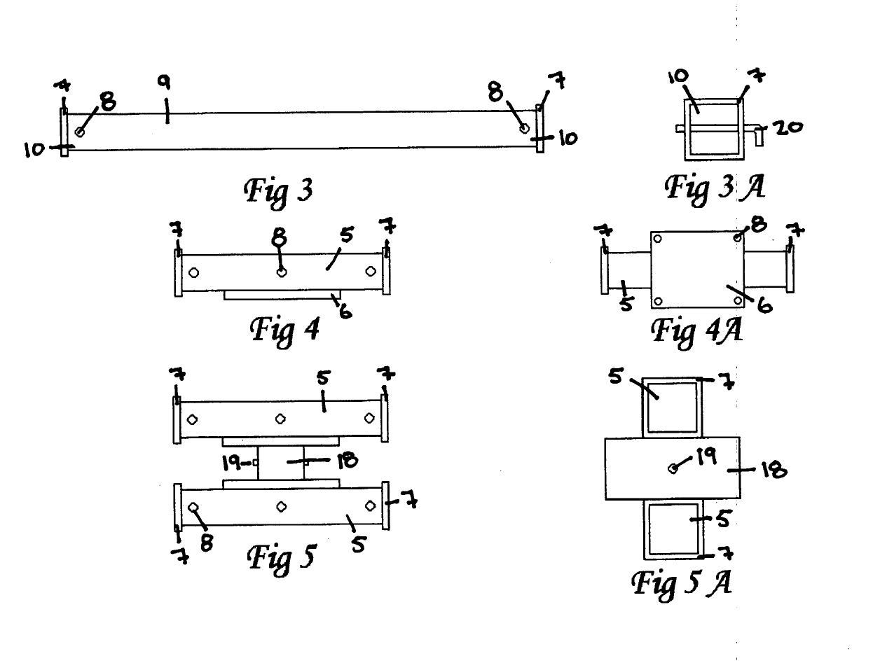

The toolbar construction kits main frame as shown in FIGS. 1 and 2 make up begins with a length of hallow steel tube identified as a main frame toolbar beam (9) as shown in FIGS. 1, 2 and 11. This beam is available as a base kit in 2, 3 and 4 foot lengths. Each end of the main frame toolbar beams (9) is fitted with are enforcement band (7) that fits over the four outer edges of the beam ends and is secured in place with a process such as welding FIGS. 3 and 3A. These bands give added support for heavy down and side load pressures on the beam end(s). There are matching pre drilled hole(s) (8) on the right and left sides and near the outer ends of the beam(s) tubing for the inserting of temporary fastener(s) (20). Both ends of toolbar beam functions as an end receiver coupler (10) FIG. 3A.

The receiver end coupler(s) (10) FIGS. 3 and 3A makes it possible for the main frame toolbar beam (9) to be increased or decreased in its width by connecting one beam to the end of another beam. This expansion is accomplished with the use of an expansion tube (22) as shown in FIG. 13. The said expansion tube is comprised of a suitable length and dimension of square steel tubing, so as to be inserted into the end coupler (10) of a toolbar beam (9), and having the other end of the said expansion tube (22) being inserted into the end coupler (10) of a second toolbar beam (9) (not illustrated). There are matching pre drilled hole(s) (8) on all four sides, and near the right and left ends of the said expansion tube for the inserting of temporary fastener(s) (20) in order to secure the toolbar beam(s) in a temporarily connected position. To reduce the width of the toolbar beam expansion, one needs only to remove a temporary fastener (20) and remove one end of the expansion tube (22) from one of the receiver end coupler(s) (10).

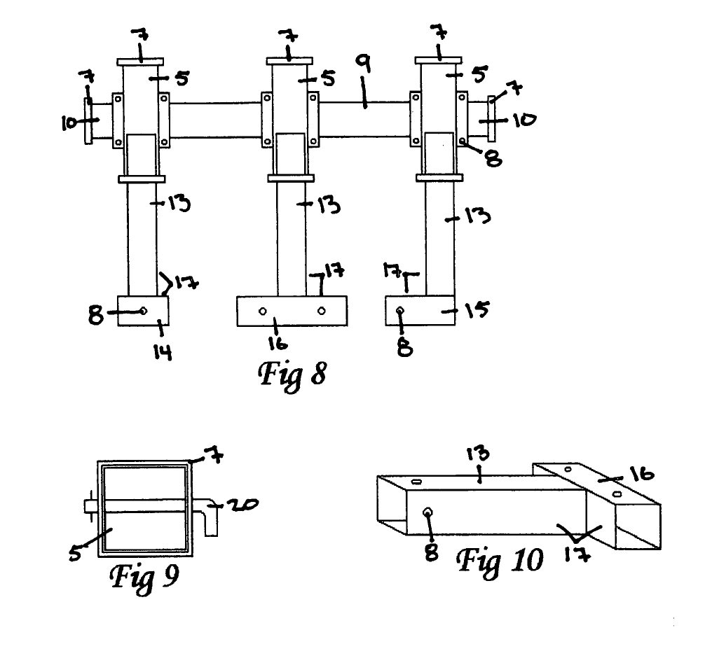

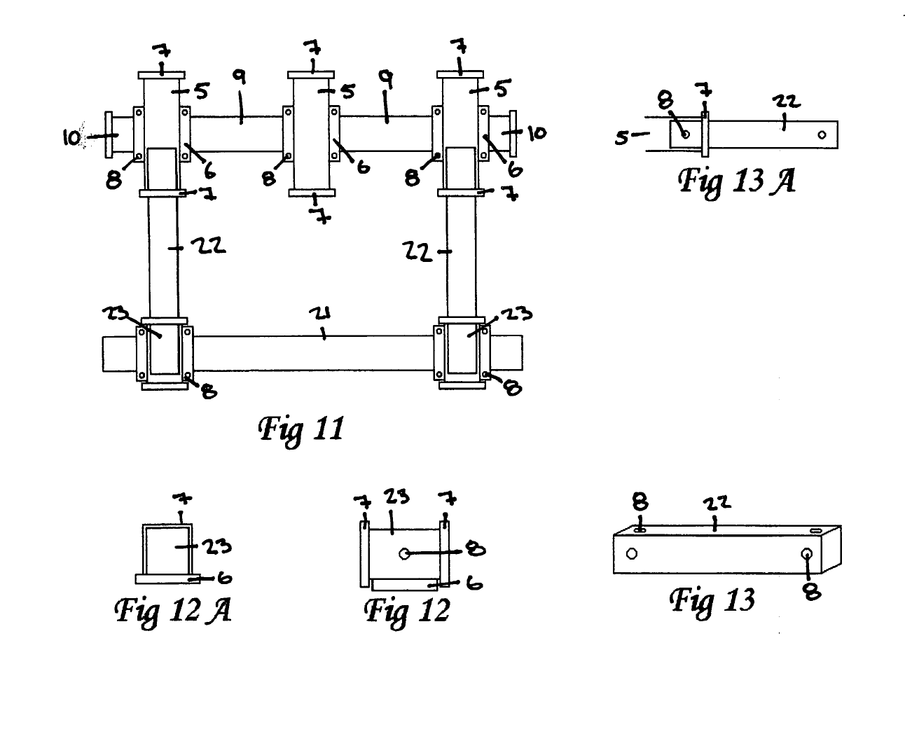

Another primary part of the toolbar construction kit that is require for assembling the main frame toolbar is identified as an adjustable receiver coupler(s) (5) as shown in FIGS. 1, 2, 4 and 5. These coupler(s) design starts with a suitable length of hallow tubing, consisting of a metal such as but not limited to steel. Both ends of the tubing are left open for the inserting of standard and expansion hardware pieces such as but not limited to expansion tubes (22) FIGS. 11 and 13A or accessory connector arm(s) (17) FIGS. 8 and 10. The adjustable receiver coupler(s) (5) can accept a single accessory hardware piece inserted and used from either end of the coupler tube, or a second accessory hardware piece can be inserted and used from the opposite end of the coupler from the first accessory hardware piece. The said coupler tubing is fitted with re enforcement band(s) (7) FIGS. 4, 4A and 13A that slides over all four side edges of the tubing and is secured in place at both of the outer ends of the tubing with a process such as welding. These bands are used to give added support to the coupler ends when they are used in heavy down and side pressure loads. The adjustable receiver coupler(s) (5) also have a series of matching pre drilled holes (8) along both the right and the left sides of the tubing FIGS. 4 and 5. These holes are used for inserting temporary fastener(s) (20) FIGS. 3A and 9. These holes are used for making adjustments and securing the accessory hardware pieces in place within the adjustable receiver coupler(s) (5).

The fore said adjustable receiver coupler(s) (5) are also fitted with Weld on connector flat plate(s) (6) FIGS. 4 and 4A. These flat plates are of a sufficient size, so as to allow for four matching pre drilled holes (8) near the outer edges of the flat plates and at an appropriate spacing so that temporary fastener(s) can be placed through the holes (8) and along the outside walls of the main frame toolbar beam (9) (not illustrated), for securing the adjustable receiver coupler (5) to the toolbar beam (9). The adjustable receiver coupler (5) can be placed on either the top or the bottom of the toolbar beam (9) in a horizontal position, and at a right angle to the toolbar beam (9), or the said coupler (5) can be attached and positioned vertically to the side of the main frame toolbar beam (9) (not illustrated). The adjustable receiver coupler (5) can also be attached at any desired location along the length of the said main frame toolbar beam. If a single adjustable receiver coupler (5) is used at a location, a temporary fastener such as a U bolt can be used to secure the said coupler (5) in position. When two adjustable receiver coupler(s) (5) are used at the same location on the toolbar beam (9), they are placed on opposite sides of the said beam (9) FIGS. 1 and 2, and a temporary fastener such as a straight bolt is used that will go through the matching pre drilled hole(s) (8) of a weld on flat plate (6) of one adjustable receiver coupler (5), and passing past the out side wall of the toolbar beam (9) and extending through the matching pre drilled hole(s) (8) in the second weld on flat plate that is connected to an adjustable receiver coupler (5) (not illustrated).

A second method of using an adjustable receiver coupler(s) (5) is in a double coupler format is illustrated in FIGS. 5 and 5A. This configuration uses a weld on receiver slider tube (18). This tube is welded at a right angle to the bottom side of one adjustable receiver coupler (5) and to the top side of a second adjustable receiver coupler (5). The slider tube uses a set screw (19) style of temporary fastener(s) that are positioned through both of the side walls of the slider tube (18). This configuration of a double adjustable receiver coupler (5) is primarily but not exclusively used on an expansion beam (21) application (not illustrated).

The main frame toolbar (1) FIGS. 1 and 2 of the toolbar construction kit also uses a quick change three point hitch connection parts, that includes a top link connector arm (11) FIGS. 1, 2 and 6 and two matching lift arm connector tube(s) (12) FIGS. 7 and 7A. The 3ph top link connector arm (11) is comprised of two matching lengths of steel flat plat(s) (11a) that are placed in a vertical/upright position. There is a set of matching pre drilled holes (8) near the top of each flat plate (11a) suitable for inserting a temporary fastener (20). There is a second set of matching pre drilled holes below the first set and at a measured distance. These series of holes (8) are used to connect and adjust the tractors 3ph top link connector (4) FIG. 2. The lower end of the flat plate(s) (11a) is secured to the forward end of the horizontally positioned insert able connector tube (11b). One flat plate (11a) is secured to the right side, and the second flat plate is secured to the left side of the said inset able connector tube (11b) with a process such as welding. The inset able connector tube (11b) is a length of square steel tubing that is of a dimension that allows the rearward end of the said insert tube (11b) to be inserted into an adjustable receiver coupler (5) FIGS. 1, 2 and 6. There are two sets of pre drilled holes (8) having one set of holes on the right side, and one set of holes on the left side, and near the rearward end of the insert able connector tube (11b) for adjustment purposes, and for the inserting of a temporary fastener that secures the top link connector arm (11) in place.

The fore said 3ph lift arm connector tube(s) (12)) FIGS. 2, 7 and 7A is comprised of a sufficient length and dimension of square steel tubing, and functions in a horizontal position so as to allow the tubing to be inserted into an adjustable receiver coupler (5), the said insert tube further having matching pre drilled holes on the right and left sides, and near the rearward most end of the insert able tubing so as to allow the insert able tube portion of the lift arm connector to be secured in place with the use of temporary fastener(s). The said lift arm connector further comprises a set of matching flat plate(s) having their rearward end secured to the right and left sides and near the forward end of the insert tube with a process such as welding, The said flat plate(s) are of sufficient length to allow for matching pre drilled hole(s) near their forward most end(s) of the flat plate so as to allow for the connection of a three point hitch lift arm connector tube (12) with the use of a temporary fastener(s) to the lower lift arm(s) (3) of a 3ph equipped power unit such as a tractor (2). The said lift arm connector tube(s) can also be used with a standard A frame style of top link connector hitch (not illustrated.

The toolbar construction kit is further comprised of a variety of accessory connector arms (17) as shown in FIGS. 8 and 10. These connector arms are used for attaching accessory tool hardware pieces, such as but not limited to cultivator shanks seed planters, gage wheels or disc gangs to the main frame toolbars (1) adjustable receiver coupler(s) (5) or the toolbar beams (9) end coupler(s) (10) (not illustrated). The said accessory connector arm(s) (17) are also considered to be expansion hardware pieces. The said accessory connector arms are of a two piece construction, starting with an insert able connector tube (13). These tubes are available in a variety of lengths, and are comprised of a hollow square, steel tubing that is of a lesser dimension than the adjustable receiver coupler(s) (5) tubing, and the toolbar end coupler(s) (10) tubing so as to allow for the insert able connector tube (13) to fit into the fore said receiver coupler(s) (5) and (10). There are matching pre drilled Hole(s) (8) on all four sides and near the forward end of the insert able tubing (13) FIG. 10. These holes (8) are used for connecting and adjusting the accessory connector arm(s) (17) into the fore said receiver coupler(s) (5) and (10) by inserting a temporary fastener (20) through holes (8) in both the said receiver coupler(s) and the insert able connector tubes (13) FIGS. 8 and 9.

The second component of the accessory connector arm (17) is the accessory connector head. These connector heads come in a variety of styles and shapes including but not limited to an I style (14), an L style (15) and a T style (16) FIG. 8. These connector heads can be used in either a horizontal or a vertical position as an expansion hardware piece, or simply as an accessory tool piece connection device.

an I style accessory connector head (14) FIG. 8 is comprised of a material such as steel, and is of a sufficient length and dimension of tubing so as to allow for the inserting and connection of a variety of accessory hardware pieces. The fore said tubing has matching pre drilled hole(s) on its right and left side(s) for inserting temporary fastener(s), such as but not limited to set screws (19) that secures a hardware piece temporarily in place. The forward side of the tubing is secured to the rearward end of the insert able tubing (13) with a process such as welding. The I style connector head can be placed for function in a horizontal or a vertical position by turning the fore said accessory connector arm (17) a quarter of a turn (45 degrees) (not illustrated).

an L style accessory connector head (15) FIG. 8 is comprised of a material such as steel, and is of a sufficient length and dimension of tubing so as to allow for the connection of a variety of accessory hardware pieces. The rearward end of the tubing (15) is secured to the rearward end of the fore said insert able connector tube (13) at a right angle and with a process such as welding. The forward end of the connector head tubing (15) allows for accessory hardware connector piece to slide over the end of forward end the tubing and to be secured temporarily at variable positions and locations over the tubing. The said L style accessory connector head can be placed for function in a horizontal or a vertical position by turning the fore said accessory connector arm (17) a quarter of a turn (45 degrees) (not illustrated).

a T style accessory connector head (16) FIGS. 8 and 10 is comprised of a material such as steel, and is of a sufficient length and dimension of tubing so as to allow for the connection of a variety of multiple accessory hardware pieces. The said tubing is connected to the rearward end of the fore said insert able connector tube (13) at its center point with a process such as welding. Both ends of the T style connector head tubing (16) are suitable for accessory hardware connector piece to be able to slide over the end of the tubing and to be secured at variable positions and locations temporarily over the tubing. The said T style accessory connector head can be placed for function in a horizontal or a vertical position by turning the fore said accessory connector arm (17) a quarter of a turn (45 degrees) (not illustrated).

Another quick change toolbar construction kit part is identified as an expansion tube (22) FIG. 13 is comprised of a suitable material such as steel, and is further comprised of a sufficient length and dimension of square tubing so as to allow of its most forward end to be inserted into an adjustable receiver coupler (5) FIGS. 13 and 13A, and further having its most rearward end inserted and connected into an expansion coupler (23). The fore said expansion tube (22) can also have one of its end inserted into a toolbar beam end coupler (10) (not illustrated) and having the other end of the expansion tube inserted and secured to the end coupler (10) of a second length of a main frame toolbar beam (9) (not illustrated) in order to temporarily expanded the width of a main frame toolbar beam, as discussed earlier in paragraph (028). The fore said expansion tube (22) further having a series of matching pre drilled holes (8) FIG. 13 near both of its outer ends and on all four sides of the tubing for the inserting of temporary fasteners (20).

The fore said expansion coupler (23) FIGS. 12 and 12A is comprised of a sufficient length of square tubing and being of a suitable material such as but not limited to steel, and having matching holes (8) on its right and left sides and at a suitable positions for the inserting of temporary fasteners. The fore said expansion coupler tubing further having re enforcement bands (7) welded to all four sides and at the outer most edges of the end(s) of the steel tubing, for giving added support for heavy down and side pressure loads, and having both ends of the said expansion coupler tubing left open for inserting and attaching or detaching an expansion tube(s) (22). The fore said expansion coupler(s) 23) are also fitted with Weld on connector flat plate(s) (6). These flat plates are of a sufficient size, so as to allow for four matching pre drilled holes (8) near the outer edges and at an appropriate spacing so that temporary fastener(s) can be placed through the pre drilled holes (8) and along the outside walls of the toolbar expansion beam (21) (not illustrated), for securing the expansion coupler (23) to the toolbar expansion beam (21). The expansion coupler (23) can be placed on either the top, or the bottom side of the said expansion beam (21) in a horizontal position, and at a right angle to the toolbar expansion beam (21), or the said coupler (23) can be attached and positioned vertically to the side of the toolbar expansion beam (21). The expansion coupler (23) can also be attached at any desired location temporarily along the length of the said toolbar expansion beam (21). If a single expansion coupler (23) is used at a location, a temporary fastener such as a U bolt can be used to secure the said coupler (5) in position. When two expansion coupler(s) (23) are used at the same location on the said expansion beam (21), they are placed on opposite sides of the said beam (21) (not illustrated), and a temporary fastener such as a straight bolt is used that will go through the matching pre drilled hole(s) (8) of a weld on flat plate (6) of one expansion coupler (23), and passing past the out side wall of the toolbar expansion beam (23) and extending through the matching pre drilled hole(s) (8) in the second weld on flat plate (6) of the second expansion coupler (23) (not illustrated).

The fore said toolbar expansion beam (21) FIG. 11 is a length of steel tubing that is of a suitable dimension so as to attach and function properly with an expansion coupler(s) (23), and with the use of temporary fastener(s), as shown in FIG. 11. A toolbar expansion beam can be the same as the fore said main frame toolbar beam (9) (not illustrated).

I claim:

1. A toolbar construction kit consisting of individual parts that are quickly and temporarily assembled into an unspecified number of sizes and styles of toolbar configurations that attach to the three point hitch on a tractor or similar type of motorized equipment piece, so as to function in a variety of tasks and job sites is comprised of;
a) a horizontal main frame toolbar beam (9) which is comprised of a suitable length of square tubing and being of a material such as but not limited to steel, and further having both of its outer ends left open so as to form and function as receiver end coupler (10) and being of a sufficient dimensions so as to be able to slide over an exchangeable, inter locking standard component, or an accessory component hardware piece, the said main frame toolbar beam (9) having matching pre drilled holes on both sides and near both outer end(s) of the fore said toolbar beam for inserting temporary fasteners that are used to secure standard and accessory hardware pieces in place within the said end coupler, the said main frame toolbar beam further having re enforcement bands (7) secured in place with a process such as welding on all four sides and at the edges of the outer most ends of the toolbar beam,
b). an adjustable receiver coupler (5) which is comprised of a length of square steel tubing, having a plurality of matching holes on its right and left sides for the inserting of temporary fasteners, the fore said adjustable receiver coupler (5) tubing further having re enforcement bands (7) welded to the four edges of the outer most ends of the steel tubing, and having both ends of the said adjustable receiver coupler tubing left open for attaching or detaching an expansion tube (22) or an accessory connector arm(s) (17), and further having connector flat plate(s) rigidly connected to the upper and lower sides of the square steel tubing with a process such as welding, the fore said flat plate(s) having a plurality of pre drilled holes near their outer edges for the inserting of temporary fasteners that can be used for securing the flat connector plate(s) to a main frame toolbar beam (9) at a horizontal or a vertical position,
c) an expansion tube (22) is comprised of a suitable material such as steel, and is further comprised of a sufficient length and dimension of square tubing so as to allow one of its most forward end being inserted into an adjustable receiver coupler (5) and having its rearward end inserted and connected into a rearward expansion coupler (23), the fore said expansion tube (22) can also be used have one end inserted into a toolbar beam end coupler (10) and having the other end of the expansion tube inserted and secured to the end coupler (10) of a second length of a main frame toolbar beam (9) in order to temporarily expanded the width of a main frame toolbar beam, the fore said expansion tube (22) further having a series of matching pre drilled holes on all four sides, and near both of its outer ends for the inserting of temporary fasteners,
d) an expansion coupler (23) which is comprised of a sufficient length of square tubing and being of a suitable material such as but not limited to steel, and having matching pre drilled holes on its right and left sides and at a suitable positions for the inserting of temporary fasteners, the fore said expansion coupler tubing further having re enforcement bands (7) welded to all four sides and at the outer most ends of the steel tubing, and having both ends of the said expansion coupler tubing left open for inserting and attaching or detaching an expansion tube (22), and further having a connector flat plate(s) rigidly connected to the bottom and/or the top side(s) of the square steel tubing with a process such as welding, the fore said flat plate being of a sufficient size, and having a plurality of holes near the outer edges for the inserting of temporary fasteners that can be used for securing the flat connector plate to an expansion toolbar beam (21),
e) an accessory connector arm(s) (17) is comprised of a sufficient length of square tubing that is of a metal such as steel, the said square tubing has its forward end dimension so as to be able to function as an insert able connector tube (13), and further having its rearward end securely connected with a process such as welding, to a variety of sizes and lengths of square tubing that form the accessory connector head (s), the said accessory connector arms can be placed so that the said connector heads function in a horizontal or a vertical position,
f) a three point hitch top link connector arm (11) is comprised of a sufficient length and dimension of square steel tubing, and functions in a horizontal position so as to allow the tubing to be inserted into an adjustable receiver coupler (5), the said insert tube further having matching pre drilled holes on the right and left sides, and near the rearward most end of the insert able tubing so as to allow the insert able tube portion of the connector arm (11) to be secured in place with the use of temporary fasteners, The fore said top link connector arm (11) further comprises a set of matching flat plates that have their lower most end(s) connected to the forward end of the insert tube in an upward/vertical position with a process such as welding, one flat plate is connected to the right side of the forward end of the insert tube, the second flat plate is connected to the left side and at the forward end of the insert tube, leaving an open distance between the two flat plates, the fore said flat plates are of a sufficient length so as to function properly with the three point hitch top link of a vehicle such as a tractor, the fore said flat plate(s) further having matching pre drilled hole(s) near their upper most end suitable for inserting a temporary fastener,
g) a three point hitch lift arm connector (12) is comprised of a sufficient length and dimension of square steel tubing, and functions in a horizontal position so as to allow the tubing to be inserted into an adjustable receiver coupler (5), the said insert tube further having matching pre drilled holes on the right and left sides, and near the rearward most end of the insert able tubing so as to allow the insert able tube portion of the lift arm connector to be secured in place with the use of temporary fasteners, the said lift arm connector further comprises a set of matching flat plate(s) having their rearward end secured to the right and left sides and near the forward end of the insert tube with a process such as welding, The said flat plate(s) are of sufficient length to allow for matching pre drilled hole(s) near their forward most end(s) of the flat plate so as to allow for the connection of the three point hitch lift arm connector end, to a towing vehicles 3ph lower lift arms (3), with the use of temporary fastener(s),

2. The Quick Change toolbar construction kit of claim 1 where in said adjustable receiver coupler (5) further comprises;
a) a weld on connector flat plate(s) (6), these flat plates are of a sufficient size, so as to allow for four matching pre drilled holes (8) near the outer edges and at an appropriate spacing so that temporary fastener(s) can be placed through the holes (8) and along the outside walls of the main frame toolbar beam (9), for securing the adjustable receiver coupler (5) to the toolbar beam (9), the said flat plates (6) allow the fore said adjustable receiver coupler (5) to be placed on either the top or the bottom in a horizontal position, and at a right angle to the toolbar beam (9), or the said coupler (5) can be attached and positioned vertically to the side of the main frame toolbar beam (9) and at a right angle, the said adjustable receiver coupler (5) can also be attached at any desired location along the length of the said main frame toolbar beam, when a single adjustable receiver coupler (5) is used at a location, a temporary fastener such as a u bolt can be used to secure the said coupler (5) in position with the use of the weld on flat plate, when two adjustable receiver coupler(s) (5) are used at the same location on the toolbar beam (9), they are placed on opposite sides of the said toolbar beam (9), and a temporary fastener such as a straight bolt is used that will go through the matching pre drilled hole(s) (8) of a weld on flat plate (6) of one adjustable receiver coupler (5), and passing past the out side wall of the toolbar beam (9) and extending through the matching pre drilled hole(s) (8) in the second adjustable receiver coupler(s) (5) weld on flat plate (6),
b) a weld on receiver slider tube (18) is a sufficient length and dimension of square tubing, and is of a sufficient metal such as steel, and welded at a right angle to the bottom side of one adjustable receiver coupler (5) and to the top side of a second adjustable receiver coupler (5), the fore said slider tube uses a set screw (19) style of temporary fastener(s) that are positioned through both of the side walls of the slider tube (18) for securing the slider tube in place on a toolbar beam, this receiver coupler (5) configuration of a double adjustable receiver coupler (5) is primarily used on a toolbar expansion beam (21) application.

3. The quick change toolbar construction kit of claim 1 wherein said accessory connector arm(s) (17) further comprises;
a) an insert able connector tube (13) that is comprised of a length of square tubing of a sufficient material such as steel, the said connector tube has four matching pre drilled holes, one on each of the four sides of the square tubing and near the forward end of the insert able connector tube, so as to allow for the inserting of a temporary fastener(s), the said tubing is of a suitable dimension, so as to allow for the insert able tube (13) to fit into an adjustable receiver coupler (5) or a main frame toolbar end coupler (10), the fore said insert able connector tube end (13) is secured in place by using a temporary fastener that is inserted through the matching pre drilled hole(s) in the adjustable receiver couplers (5) or the toolbar end coupler(s) (10) and the pre drilled hole(s) in the insert able connector tube(s) (13),
b) an I style accessory connector head (14) is comprised of a material such as steel, and is of a sufficient length and dimension of tubing so as to allow for the inserting and connection of a variety of accessory hardware pieces, the fore said tubing has matching pre drilled hole(s) on its right and left side(s) for inserting of temporary fastener(s), the forward side of the tubing is secured to the rearward end of the insert able tubing (13) with a process such as welding, the I style connector head can be placed for function in a horizontal or a vertical position by turning the accessory connector arm (17) a quarter of a turn (45°),
c) an L style accessory connector head (15) is comprised of a material such as steel, and is of a sufficient length and dimension of tubing so as to allow for the connection of a variety of accessory hardware pieces, one end of the tubing is secured to the rearward end of the fore said insert able connector tube (13) at a right angle and with a process such as welding, the forward end of the connector head tubing (15) is of a sufficient dimension that allows for accessory hardware connector piece to slide over the end of the tubing and to be secured at variable positions and locations over the tubing, the said L style accessory connector head can be placed for function in a horizontal or a vertical position by turning the fore said accessory connector arm (17) a quarter of a turn (45°),
d) a T style accessory connector head (16) is comprised of a material such as steel, the said tubing is connected at its center point to the rearward end of the fore said insert able connector tube (13) with a process such as welding, the said connector head (16)o is of a sufficient length and dimension of tubing so as to allow for the connection of a variety of multiple accessory hardware pieces, both the right and left ends of the T style connector head tubing (16) are of a suitable dimension for allowing accessory hardware connector piece to slide over the ends of the tubing and to be secured at variable positions and locations over the tubing, the said T style accessory connector head, can be placed for function in a horizontal or a vertical position by turning the fore said accessory connector arm (17) a quarter of a turn (45°).
